(19) United States
(12) Patent Application Publication
(10) Pub. No.: US 2009/0308208 A1
(43) Pub. Date: Dec. 17, 2009

(54) Anti-Slip Pipe Threading Wrench

(76) Inventor: Glen Russel Stevick, Berkeley, CA (US)

Correspondence Address: GLEN RUSSELL STEVICK, 1636 WALNUT STREET, BERKELEY, CA, 94709, US

(21) Appl. No.: 12/138,244

(22) Filed: Jun. 12, 2008

(51) Int. Cl. B25B 13/46

(52) U.S. Cl. 81/60

(57) ABSTRACT

This invention relates to a standard pipe threading wrench and prevents an inherent malfunction when ratcheting. This type of wrench has been on the market for many decades unchanged. To use the wrench the die is inserted into the wrench head. The die, with attached wrench, is slipped over the end of an unthreaded pipe. The wrench handle is used to rotate the die and cut tapered threads into the pipe end. The wrench head rotates the die in one direction and ratchets in the opposite direction, allowing the user to reassert leverage on the handle from the same position. The ratcheting action is accomplished via a tapered and spring loaded pawl in the wrench head. The ratcheting teeth are in the die. The pawl also performs a second function holding the die in the wrench head as it is extended radially inward between two retaining rings in the die. If the user moves the handle out of the plane perpendicular to the pipe being threaded, the pawl will ride against one of the retaining rings and slip past the die ratchet teeth without engaging. The resulting rotational slippage can, and has caused, serious injury if the user is in a precarious position. This invention removes the retaining function from the ratcheting pawl preventing slippage and enhancing safety.

### CROSS REFERENCE TO RELATED APPLICATIONS

not applicable

### FEDERALLY SPONSORED RESEARCH

not applicable

### SEQUENCE LISTING OR PROGRAM

not applicable

### BACKGROUND OF INVENTION

This invention relates to an anti-slip thread wrench that prevents malfunction when ratcheting. The anti-slip pipe thread wrench was developed from a standard pipe thread wrench manufactured by Rigid Tool. This type of wrench has been on the market for many decades unchanged. To use the wrench the die is inserted into the wrench head. The die, with attached wrench, is slipped over the end of an unthreaded pipe. The wrench handle is used to rotate the die and cut tapered threads into the pipe end.

The wrench head rotates the die in one direction and ratchets in the opposite direction, allowing the user to reassert leverage on the handle from the same position. The ratcheting action is accomplished via the pawl in the wrench head, which is tapered and spring loaded, and the ratcheting teeth in the die.

The pawl performs a second function. It holds the die in the wrench head by extending radially inward between the two die retaining rings. If the user moves the handle up or down out of the plane perpendicular to the pipe being threaded and passing through the pawl, the pawl will occasionally ride against one of the retaining rings and slip past the die ratchet teeth without engaging. If the user is pulling in a rhythm and standing precariously, the user may fall and be injured. The pulling necessary to thread a 2.5 inch or larger pipe is significant. Accidents have happened in this manner resulting in the warning label on the wrench handle: WARNING Fully engage ratchet to prevent slipping and serious injury.

Restated, the problem is the pawl performing two functions: (1) ratcheting and (2) retaining the die in the wrench head. The retaining function causes a malfunction in the ratcheting function when the pawl rides one of the two rings past the ratcheting teeth, resulting in slipping.

### BACKGROUND OF THE INVENTION PRIOR ACT

There are many patents on ratcheting tools. They all consist of a gear, a first arc and a pawl between the body of the tool and the gear. The pawl transmits torque in an opposite rotational directions. The pawl teeth define the second arc.

An improvement on the pawl has been made under patent Ser. No. 11/353,645, using a plurality of teeth facing into the gear. But this improvement does not address the problem of defect in the ratcheting function when the pawl rides along a retaining ring and past the rotational drive teeth without engaging. A plurality of teeth exacerbates the problem as they are easier to slip past if the pawl is radially held away by friction contact with a retaining ring.

Another ratchet pipe wrench has a C-shaped head and a C-shaped engaging member which is rotatably engaged with the head and a C-shaped positioning ring is securely connected to the head and retains the engaging member (pipe). This design addresses maintaining engagement with the pipe being threaded and does not address engagement in the ratcheting system. (see for example patent Ser. No. 11/091,511)

Some pipe wrenches have the probes where the pawl protrudes beyond the handle during change in the ratcheting direction and thus adversely affecting operation of the wrench. This problem has been solved by a design where the handle comprises of a first lateral side and a second lateral side opposite to the first lateral side with a web between the handle and the head. This design makes milling easier but does not address ratcheting malfunction. (see for example Patent No. 20020166416)

A different design has two pawl members connected by a spring used to engage with the teeth of the ring member, and each pawl member has a toothed inner periphery which is engaged with the teeth. The ring member is engaged with two pawls. This design gives greater torque but again does not address ratcheting malfunction. (see for instance Paten No. 20020084163).

An improved ratchet well structure is outlined in Patent No. 20010054531, which reduces the likelihood of mechanical failure (e.g. cracks) in ratchet ts but does not improve the functioning of the ratchet. Other improvements on wrenches include improved adjusting structures (U.S. Pat. No. 6,431,030), a wrench body having a shank (U.S. Pat. No. 6,457,388), a wrench having the opening in the head formed from the top with the pawl being disposed adjacent to the gear (U.S. Pat. No. 6,260,448), one where the gear wheel is rotatably mounted (U.S. Pat. No. 6,230,591), but none of these address the problem of ratchet malfunction due to the pawl riding a retaining ring and not engaging the ratcheting teeth.

### SUMMARY

An anti-slip pipe thread wrench to prevent serious injury when the wrench is not fully engaged. The pawl performs two functions: a) ratcheting and, b) retaining the die in the wrench head. The retaining function causes a malfunction in the ratcheting function when the pawl rides on of the rings past the ratcheting teeth, resulting in slipping. If the user is pulling in a rhythm and standing precariously, the user may fall and be injured. The pulling necessary to thread a 2.5 inch or larger pipe is significant. Accidents have happened in this manner resulting in the warning labels on the wrench handle: WARNING Fully engage ratchet to prevent slipping and serious injury.

The solution to the slipping problem is to install a retaining pawl, to engage the retaining rings. The retaining pawl is slightly larger than the ratcheting pawl, preventing the ratcheting pawl from contacting the rings. Thus, the ratcheting pawl is free to ratchet and only ratchet. Testing of the prototype wrench shown in the figures below, indicates that slipping can be completely eliminated.

Testing also indicated that the closer the retaining pawl is to the ratcheting pawl, the more effective it is. In the prototype, the retaining pawl was made rectangular in cross section to maximize engagement area with the retaining rings to reduce wear. The central axis of the retaining pawl was made coincident with the wrench handle to allow use of the same wrench head casting. The retaining pawl is also spring loaded, so that it can be retracted by the user with the thumb via the handle. The end of the handle, was made solid to form a base for the retaining pawl spring.

### DRAWINGS FIGURES

FIG. 1 Overall drawing of the pipe threading wrench, including the handle (3) head (2) and die (6).

FIG. 2 Pipe threading wrench components: including the handle (3) head (2) and guide pawl spring (8)

FIG. 3 Pipe threading die showing the ratcheting teeth (11), the thread cutting teeth (12), inner retaining ring (13) and outer retaining ring (10).

FIG. 4 Pipe threading wrench head (16) and components: ratcheting pawl (14), ratcheting pawl handle (18), retaining pawl (15) and retaining pawl handle (17).

FIG. 5 Closeup of the pipe threading wrench components: ratcheting pawl (14), ratcheting pawl handle (18), retaining pawl (15) and retaining pawl handle (17).

### DRAWINGS—REFERENCE NUMERALS

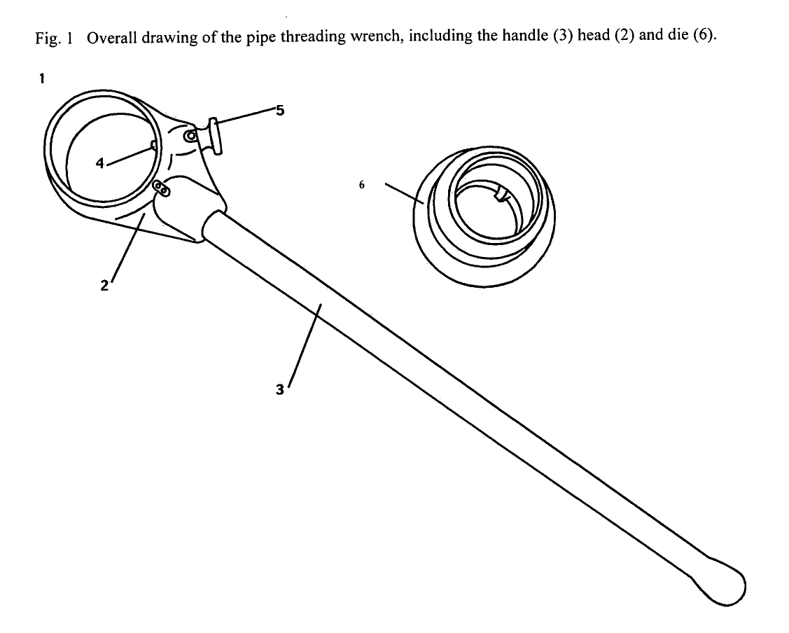

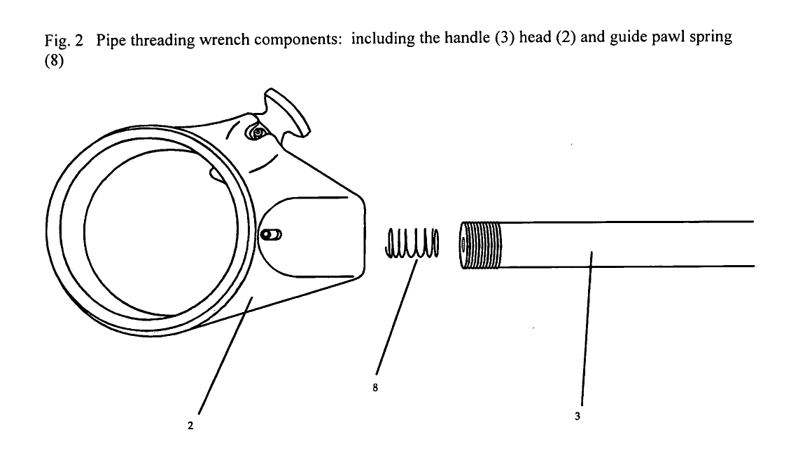

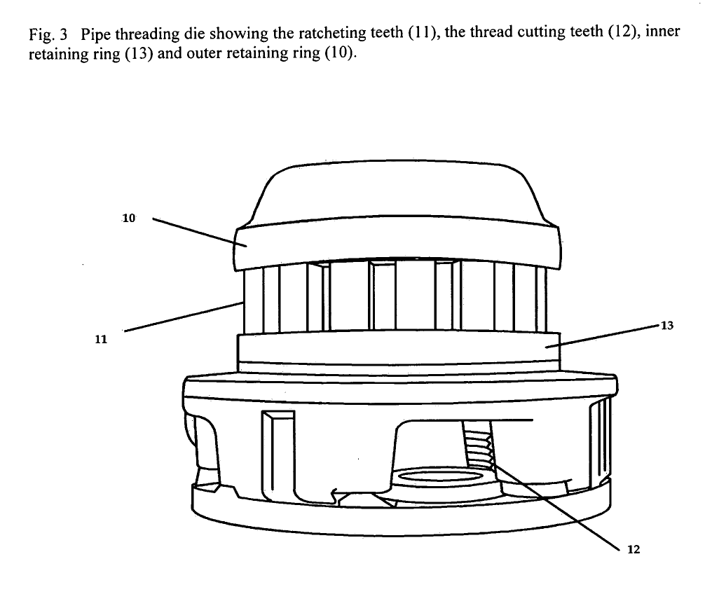

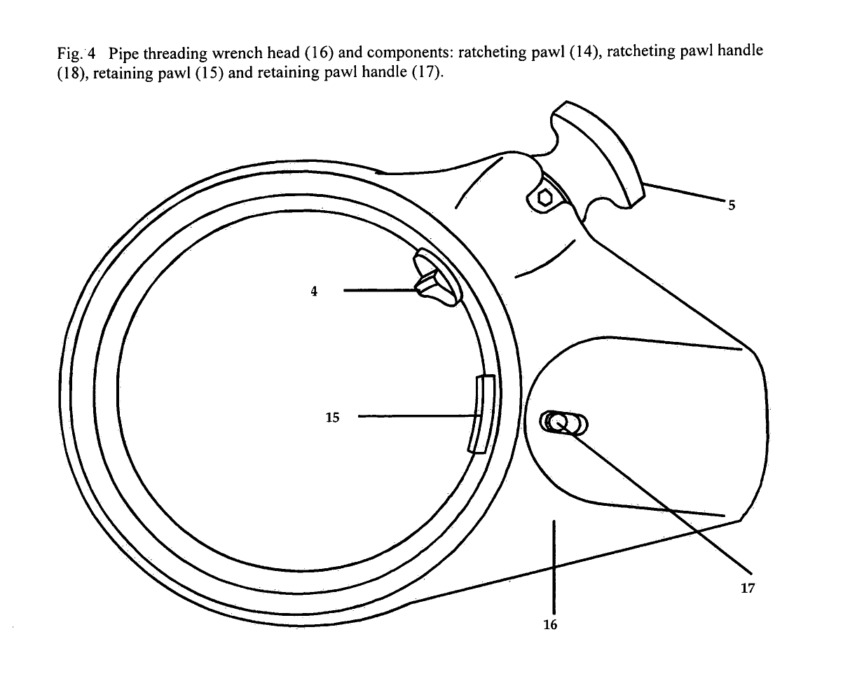

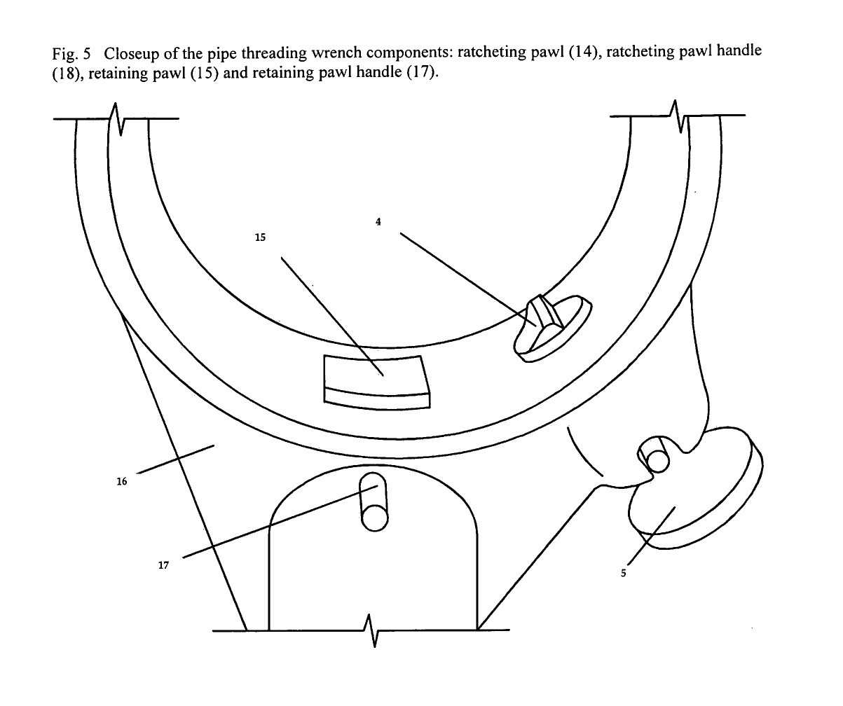

The entire pipe threading wrench (1) is shown in FIG. 1, including the handle (3) head (2) and die (6). The major pipe threading wrench components including the handle (3) head (2) and guide pawl spring (8) are shown in FIG. 2. A typical pipe threading die is shown in FIG. 3 with the ratcheting teeth (11), the thread cutting teeth (1 2), inner retaining ring (13) and outer retaining ring (10). The new redesigned pipe threading wrench head (16), and subject of this patent, is shown in FIG. 4 where the ratcheting pawl (14) and retaining pawl (15) have separate functions. Their respective actuation handles: ratcheting pawl handle (18) and retaining pawl handle (17) are also shown and labeled. FIG. 5 shows a closeup of the same components: ratcheting pawl (14), ratcheting pawl handle (18), retaining pawl (15) and retaining pawl handle (17).

### Detailed Description—First Embodiment

The solution to the slipping problem is to install a retaining pawl, to engage the retaining rings. The retaining pawl is slightly larger than the ratcheting pawl, preventing the ratcheting pawl from contacting the rings. Thus, the ratcheting pawl is free to ratchet and only ratchet. Testing of the prototype wrench, indicates that slipping can be completely eliminated.

Testing also indicated that the closer the retaining pawl is to the ratcheting pawl, the more effective it is. In the prototype, the retaining pawl was made rectangular in cross section to maximize engagement area with the retaining rings to reduce wear. The central axis of the retaining pawl was made coincident with the wrench handle to allow use of the same wrench head casting. The retaining pawl is also spring loaded, so that it can be retracted by the user with the thumb via the handle. The end of the handle, was made solid to form a base for the retaining pawl spring.

1. In combination a pipe threading wrench head (2), ratcheting pawl (4) and comprising, retaining pawl or pin (15), means for extension of the retaining pawl,

2. And holding the retaining pawl, in place, means for retracting the retaining pawl with a handle or lever (17),

3. With the same hand that is holding the wrench, leaving the users second hand free to manipulate the die.

4. Device according to claim 1-3, wherein the retaining pawl (15) is removable,

5. Device according to claim 1-3, wherein the retaining pawl replaceable

6. Device according to claim 1-3, wherein the retaining pawl interchangeable for maintenance purposes.

7. A ratcheting pipe threader device separating the functions of ratcheting the die and retaining the die with an additional pawl or additional pawls or pins that bear against the die retaining rings.

8. A ratcheting pipe threader device separating the functions of ratcheting the die and retaining the die with a tube, or partial tube or tubes, surrounding or adjacent to the ratcheting pawl;

9. The tube, or partial tube or tubes, surrounding or adjacent to the ratcheting pawl performing the function of retaining the die.

10. A ratcheting pipe threader device separating the functions of ratcheting the die and retaining the die with a pin or pins, protrusion or protrusions extending radially inward between the die retaining rings.
